(19) United States
(12) Patent Application Publication
(10) Pub. No.: US 2004/0260803 A1
(43) Pub. Date: Dec. 23, 2004

(54) Apparatus maintenance method, server computer for apparatus maintenance system, and electronic apparatus

(75) Inventor: Junichi Nakamura, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/378,086

(22) Filed: Mar. 4, 2003

(30) Foreign Application Priority Data
Mar. 4, 2002 (JP) P2002-057973

(51) Int. Cl. G06F 15/173

(52) U.S. Cl. 709/224

(57) ABSTRACT

In the case where an error occurs or a regular reporting time has come, each printer that is a user apparatus transmits maintenance information to a management server. Based on the maintenance information acquired from each printer, the management server determines whether or not each printer corresponds to a predetermined decision condition and a condition concerning the maintenance of the printer needs to be changed. In the case where it has determined that update is needed, the management server causes each printer to execute rewriting of a ROM through a remote control computer. As a result, each printer can prepare for an error that will occur in the future and can be remotely maintained efficiently.

### BACKGROUND OF THE INVENTION

The present invention relates to an apparatus maintenance method, a server computer for an apparatus maintenance system, and an electronic apparatus.

User apparatuses, such as facsimiles, printers, and their combined machines, which are used in companies, are normally subject to contracts for maintenance and inspection services with sales companies or leasing companies. When some sort of error occurs in such an apparatus, the user who uses the apparatus contacts the company that has a contract for the maintenance and inspection service, in order to get the maintenance and inspection service. The informed company sends a maintenance worker and has the maintenance worker eliminate the error in the user apparatus. That is, conventionally, to eliminate an error occurred in a user apparatus, the user has to contact a sales company or leasing company, and therefore bears some burden.

In this respect, remote maintenance techniques have been developed that transmit maintenance information to a management server via a computer network regularly or when an error occurs so that a sales company or leasing company automatically monitors a user apparatus without any report from the user.

As this type of technique, there is an information collecting system in remote maintenance disclosed in, for example, Japanese Laid-open Patent Publication No. Hei 4-338854. The technique described in this publication determines an error according to the processes of a program installed in a user apparatus. A server computer transmits various process signals to a user apparatus in accordance with the processes of the installed program, and acquires information about the user apparatus on which an error has occurred, while maintaining connection to the user apparatus. This can ensure efficient collection of information about the user apparatus and swift recovery from the error that occurred in the user apparatus.

According to the technique, however, the same program executes processes in all the user apparatuses and processes that are performed on the user apparatuses by the server computer. Every time some sort of error occurs, therefore, the server computer collects information about the error and conducts recovery operation properly. Even in the case where the same error frequently occurs in one user apparatus and it is predictable that the error is likely to reoccur, nothing is done until that error actually occurs. That is, no predictive measures can be taken against an error that will occur in the future.

### SUMMARY OF THE INVENTION

It is an object of the present invention to provide an apparatus maintenance method, a server computer for an apparatus maintenance system, and an electronic apparatus, which can prepare for an error that may occur in the future and can carry out efficient remote maintenance of individual user apparatuses.

To achieve the object, the present invention provides a method in which a server computer performs remote maintenance by monitoring a user apparatus via a computer network, the method comprising a step that records maintenance information received from the user apparatus; a step that generates and stores a decision condition for predicatively determining occurrence of a problem in the user apparatus based on plural pieces of the maintenance information; and a step that predicatively determines occurrence of a problem in the user apparatus based on the decision condition and the maintenance information.

The present invention also provides a method in which a server computer performs remote maintenance by monitoring a user apparatus via a computer network, the method comprising a step that records job information received from the user apparatus; a step that generates and stores a decision condition for predicatively determining occurrence of a problem in the user apparatus based on plural pieces of the job information; and a step that predicatively determines occurrence of a problem in the user apparatus based on the job information received from the user apparatus through collation with the decision condition.

The present invention further provides a server computer, connected to a user apparatus via a computer network, for performing remote maintenance by monitoring the user apparatus, the server computer comprising recording means, which records maintenance information received from the user apparatus; generation means, which generates and stores a decision condition for predicatively determining occurrence of a problem in the user apparatus based on the maintenance information; and decision means, which predicatively determines occurrence of a problem in the user apparatus based on the decision condition and the maintenance information.

In addition, the present invention provides an electronic apparatus, which is monitored by a server computer present at a remote location through execution of transmission and reception of information with the server computer, the electronic apparatus comprising apparatus updating means that updates maintenance-oriented settings when receiving a new decision condition for prediction of occurrence of a problem from the server computer.

Further, the present invention provides an electronic apparatus, which is monitored by a server computer present at a remote location through execution of transmission and reception of information with the server computer, the electronic apparatus comprising means that receives a setting condition from the server computer and stores this setting condition.

### BRIEF DESCRIPTION OF THE DRAWINGS

The features of the invention that are believed to be novel will become particularity apparent in the appended claims. The invention, together with objects and advantages thereof, may best be understood by reference to the following description of the presently preferred embodiments together with the accompanying drawings.

FIG. 1 is a schematic structural diagram of an apparatus maintenance system according to one embodiment of the invention;

FIG. 2 is a block diagram showing the electric structure of a user apparatus according to one embodiment;

FIG. 3 is a data structural diagram of transmission information stored in a maintenance management card;

FIG. 4 is a data structural diagram of point information stored in a ROM of the user apparatus;

FIG. 5 is a data structural diagram of maintenance information and job information, which are stored in an MIB;

FIG. 6 is a data structural diagram of apparatus information recorded in an apparatus information memory section;

FIG. 7 is a data structural diagram showing change conditions and their change contents stored in an analysis/decision condition information memory section;

FIG. 8 is a data structural diagram of problem information stored in a problem information memory section;

FIG. 9 is a data structural diagram of regular information stored in a regular information memory section;

FIG. 10 is a data structural diagram of job information stored in a job information memory section;

FIG. 11 is a flowchart of a process associated with the initialization of a user apparatus;

FIG. 12 is a flowchart of a process associated with transmission of problem information from a user apparatus;

FIG. 13 is a flowchart of a process associated with transmission of regular information from a user apparatus and a process associated with how to handle maintenance information in a management server;

FIG. 14 is a flowchart of a process associated with a process associated with how to handle maintenance information and a process associated with acquisition of maintenance information;

FIG. 15 is a flowchart of a work process, which is executed based on maintenance information;

FIG. 16 is a diagram for explaining a list display screen to be shown on the display of a monitor console;

FIG. 17 is a diagram for explaining a detailed information screen to be shown on the display; and

FIG. 18 is a diagram for explaining a job information screen to be shown on the display.

### DETAILED DESCRIPTION OF THE PREFERRED EMBODIMENTS

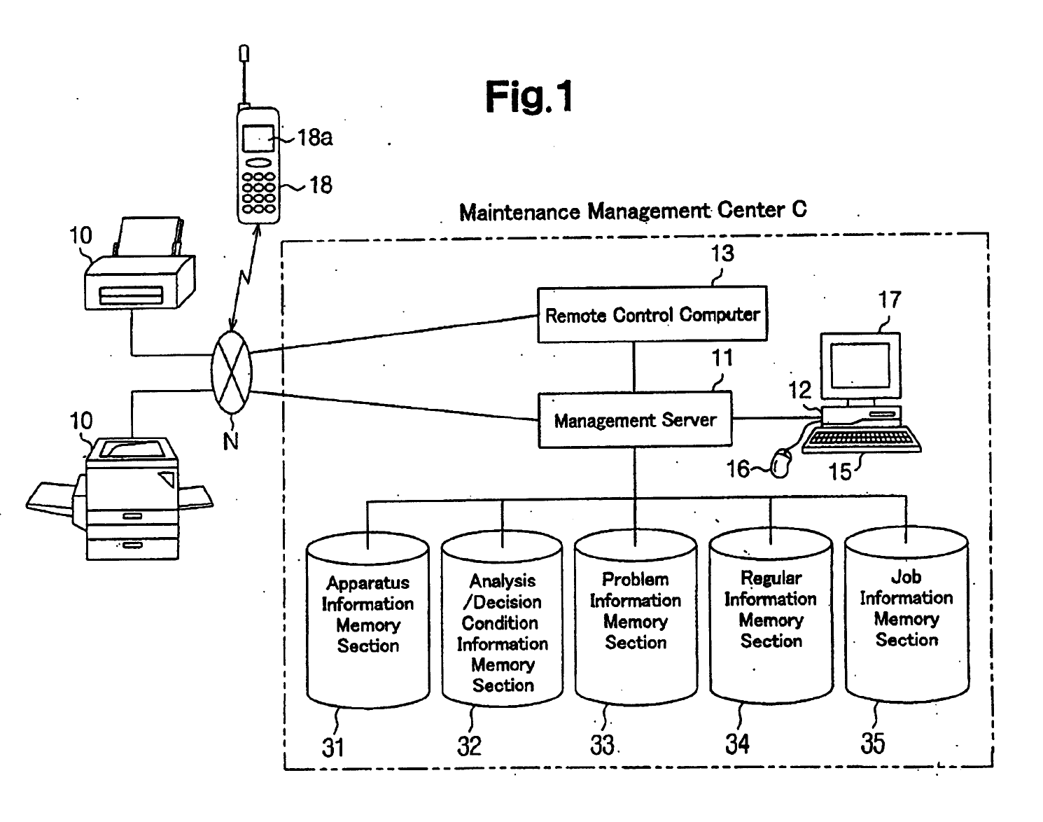

One preferred embodiment of an apparatus maintenance system that embodies the present invention will be described below with reference to FIGS. 1 to 18.

As shown in FIG. 1, a printer 10 as a user apparatus and an electronic apparatus is connected to a maintenance and management center C via a network N. The maintenance and management center C is connected to a portable terminal 18 via the network N. The portable terminal 18 is carried around by a maintenance worker who does maintenance work on the printer 10. The portable terminal 18 has a display section 18a, which shows information transmitted from the maintenance and management center C.

The printer 10, which is to be maintained and managed, will be elaborated below.

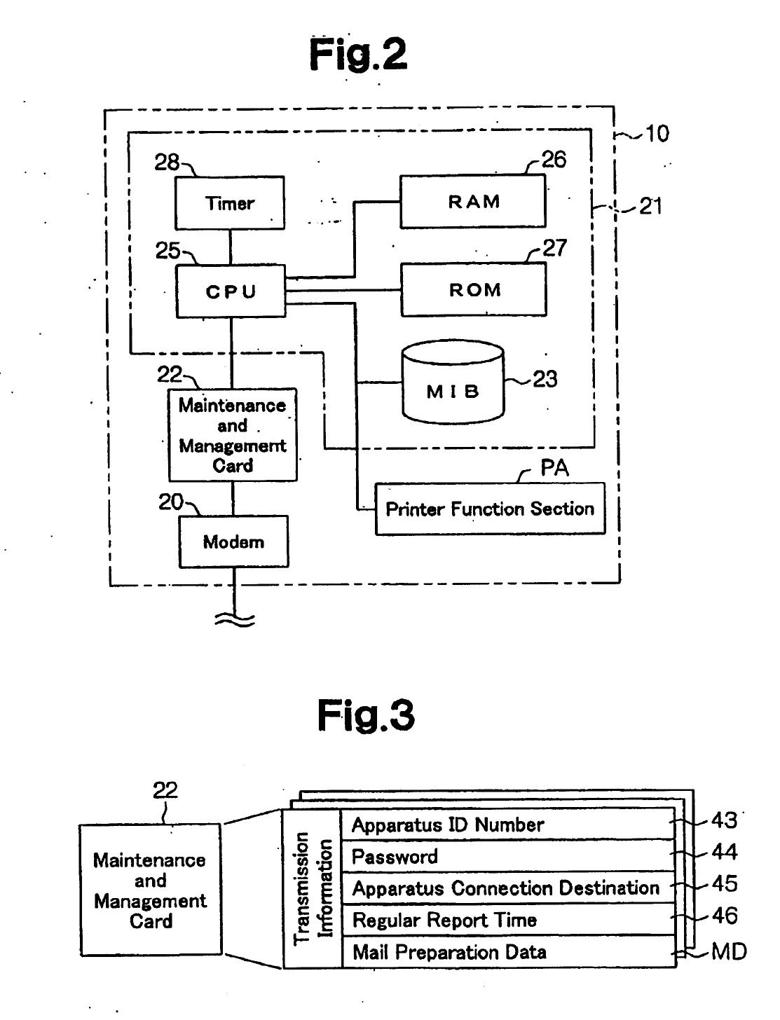

The printer 10 is, for example, an ink jet type printer, a laser printer, or a combined machine that has a printer capability. This printer 10 has a printer function section PA, a modem 20, a control section 21, and a maintenance and management card 22 as memory means, as shown in FIG. 2. The printer function section PA is a body portion that drives an unillustrated carriage, sheet feed rollers, etc. to execute printing. The modem 20 is a transmitter for executing transmission to the maintenance and management center C.

The maintenance and management card 22 is provided between the modem 20 and the control section 21. This maintenance and management card 22 stores transmission information, which is needed at the time the modem 20 makes transmission to the maintenance and management center C. This transmission information includes an apparatus ID number 43, a password 44, an apparatus connection destination 45, a regular report time 46, and mail preparation data MD, as shown in FIG. 3. The apparatus ID number 43 is an identification number specific to each printer 10, and the password 44 is a password for the maintenance and management center C to verify the printer 10. The apparatus connection destination 45 is an IP (Internet Protocol) address of the connection destination of the printer 10 or the maintenance and management card 22. The regular report time 46 is a transmission time for regular information, which is set for each printer 10 and is initialized at the time the printer 10 is set. The mail preparation data MD is data for converting information to be transmitted to a mail format.

The control section 21 has a CPU 25 as apparatus updating means, a RAM 26, a ROM 27, a timer 28, and an MIB (Management Information Base) 23 as shown in FIG. 2. The RAM 26 temporarily stores data during processing done by the CPU 25 and stores an accumulated error point. The accumulated error point is the value of accumulation of error points, determined in advance respectively for various error events that may occur in the printer 10, and is updated every time an error occurs.

The ROM 27 is a programmable ROM (EEPROM), such as a flash memory. Stored in the ROM 27 are a computer program for controlling the CPU 25, a transmission decision reference value, and point information. The transmission decision reference value is a reference value that is referred to at the time the CPU 25 determines whether or not to make communication with the maintenance and management center C, and is set to, for example, “10.” When the accumulated error point in the RAM 26 reaches this transmission decision reference value, the CPU 25 makes communication with the maintenance and management center C via the modem 20.

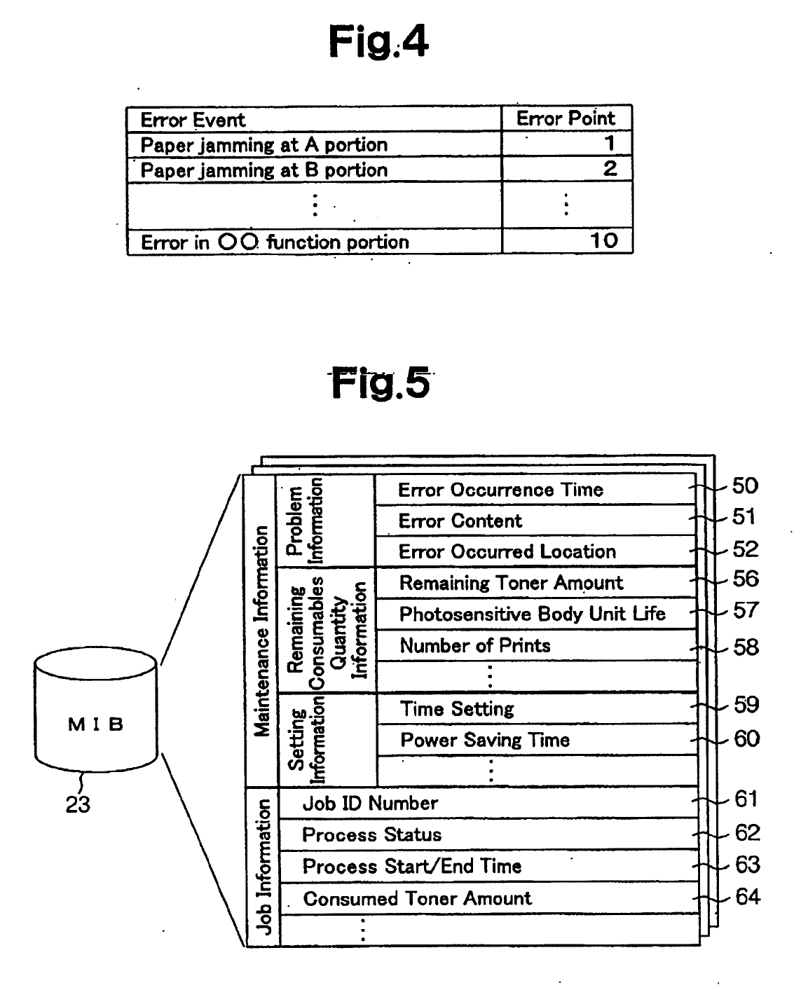

As shown in FIG. 4, the point information includes an error event occurred and an error point corresponding to the error event. This error point represents the degree of importance of an error. That is, a value smaller than the transmission decision reference value of 10 is set as an error point for a light error event (e.g., an error, such as paper jamming, which can easily eliminated by a user without the help of a maintenance worker). When a light error occurs plural times, therefore, information about those errors is collectively transmitted to the maintenance and management center C. A value greater than the transmission decision reference value of 10 is set as an error point for a significant error event, such as a system error in the program (e.g., an error that should be eliminated by a maintenance worker). When a significant error occurs even once, therefore, information about that error is immediately transmitted to the maintenance and management center C.

The CPU 25 in FIG. 2 controls the printer function section PA and performs writing and reading of information with respect to the MIB 23. The CPU 25 also reads necessary information from the RAM 26 and ROM 27, and stores the accumulated error point in the RAM 26. That is, when an error occurs, the CPU 25 reads an error point corresponding to that error from the ROM 27 and the current accumulated error point from the RAM 26, adds them, and compares the accumulated value with the transmission decision reference value of 10. When the accumulated error point becomes equal to or greater than 10, the CPU 25 transmits problem information or information about the content of the error to the maintenance and management center C and resets the accumulated error point in the RAM 26 to 0. In initializing the printer 10, the CPU 25 writes the regular report time 46 in the maintenance and management card 22, in accordance with an instruction from the maintenance and management center C.

As shown in FIG. 5, the MIB 23 has maintenance information and job information recorded therein. When some change is made to that information, the information is automatically updated by the CPU 25.

The maintenance information is information necessary for maintenance and management for the printer 10 and includes the problem information and regular information.

The problem information is information about the occurrence of an error, as mentioned above. When the accumulated error point reaches the transmission decision reference value, this stored problem information is sent to the maintenance and management center C and the stored problem information is deleted. The problem information includes an error occurrence time 50, an error content 51, and an error occurred location 52. The error occurrence time 50 indicates the time at which an error has occurred, the error content 51 indicates the content of an error that occurred in the printer 10, and the error occurred location 52 indicates the location at which an error has occurred.

The regular information is information to be transmitted to the maintenance and management center C every given time, includes remaining consumables quantity information and setting information, and is automatically updated by the CPU 25. The remaining consumables quantity information is information about the remaining quantity or the accumulated quantity of usage of a consumable item that is consumed by the usage of the printer 10, and includes a remaining toner amount 56, a photosensitive body unit life 57, and a number of prints 58. The remaining toner amount 56 represents the remaining amount (by percentage) of toner stored in the printer 10. The photosensitive body unit life 57 represents the remaining life (by percentage) of a photosensitive body incorporated in the printer 10. The number of prints 58 is the total number of sheets printed up to the present time since the beginning of the use of the printer 10. The setting information is information on the settings of the printer 10 about consumed power, and includes time setting 59 and power saving time 60. The time setting 59 indicates the time set to a timer built in the printer 10, and the power saving time 60 indicates the interval of the power saving mode.

The job information is detailed information about how the printer 10 is used, and is stored in the MIB 23 until it is transmitted to the maintenance and management center C. That is, when the job information is transmitted to the maintenance and management center C when requested by the maintenance and management center C, the transmitted job information is deleted. The job information includes a job ID number 61, a process status 62, a process start/end time 63, and a consumed toner amount 64. The job ID number 61 is an identification number given to specify a process (job) executed in the printer 10. The process status 62 indicates how the process went, i.e., whether the process has been completed, has failed halfway and terminated, or the like. The process start/end time 63 indicates the time at which the process was started and the time at which it has ended. The consumed toner amount 64 indicates the consumed amount of toner used in this process.

The maintenance and management center C will be discussed next.

As shown in FIG. 1, the maintenance and management center C has a management server 11 as a server computer, a monitor console 12, and a remote control computer 13. The monitor console 12 and the remote control computer 13 are connected to the management server 11. The management server 11 functions as maintenance information recording means, decision condition generation means, decision means, transmission means, and updating means.

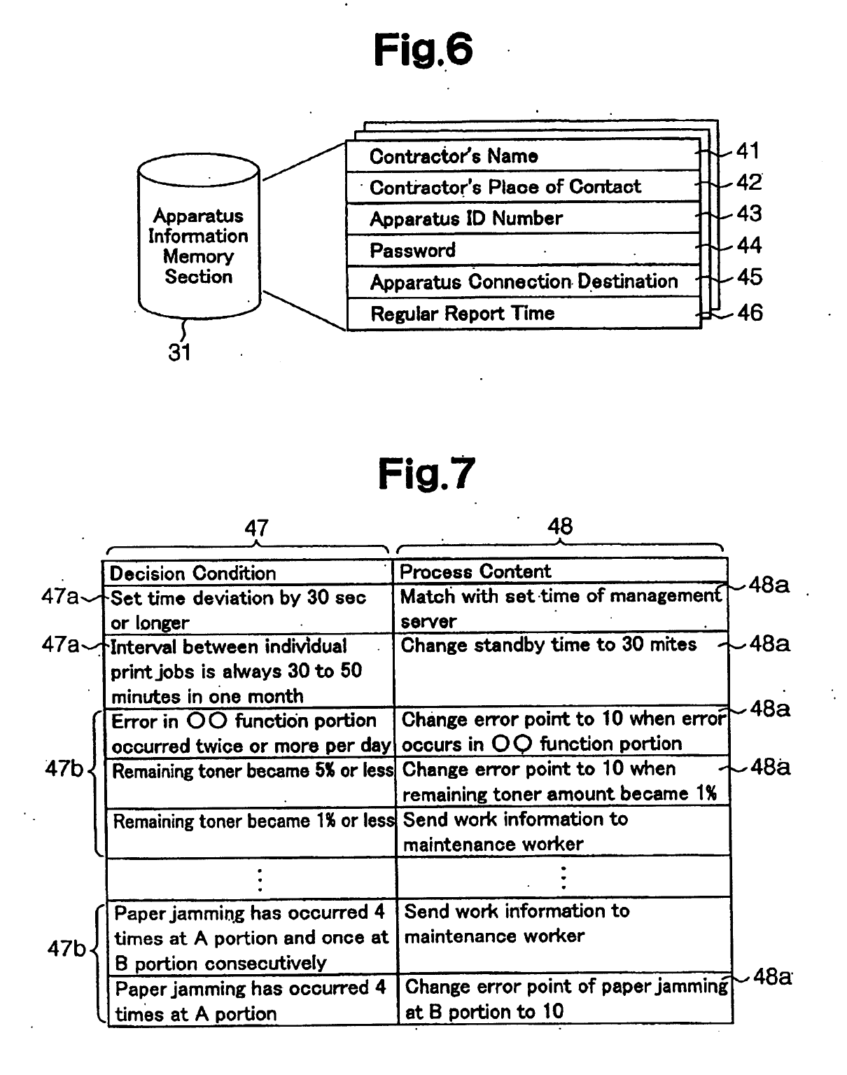

The monitor console 12 is a monitor apparatus for an operator. This monitor console 12 is connected with a keyboard 15, a mouse 16, and a display 17. Inputting of a contractor's name 41 and a contractor's place of contact 42 (see FIG. 6) or the like and an instruction to send a maintenance worker or the like are made on the monitor console 12 by an operator via those keyboard 15 and mouse 16. The display 17 shows the maintenance information and the information transmitted from each printer 10. The operator views the maintenance information and job information of each printer 10 through the display 17.

The remote control computer 13 is connected to each printer 10 via the network N. The remote control computer 13 can remotely manipulate each printer 10. That is, the remote control computer 13 gives an instruction to the CPU 25 of the printer 10 and performs a remote operation, such as rewriting of data in the ROM 27, acquisition of job information, and ink flashing for maintenance of the nozzles of the head in case of an ink jet printer.

The management server 11 receives the apparatus ID number 43, the password 44, etc. from each printer 10 to verify the printer 10, or receives the maintenance information and stores it. The management server 11 has an unillustrated timer, RAM and the like built therein, and has an apparatus information memory section 31, an analysis/decision condition information memory section 32, a problem information memory section 33, a regular information memory section 34, and a job information memory section 35, as shown in FIG. 1.

The apparatus information memory section 31 stores apparatus information about services on each printer 10 and information specific to the printer 10, printer by printer. As shown in FIG. 6, the apparatus information includes the contractor's name 41, the contractor's place of contact 42, the apparatus ID number 43, the password 44, the apparatus connection destination 45, and the regular report time 46. The contractor's name 41 indicates the name of a contractor who gets remote maintenance services in this embodiment, and the contractor's place of contact 42 indicates the address and telephone number or the like of the contractor.

The analysis/decision condition information memory section 32 stores mail analysis information and decision condition information. The mail analysis information is used in analysis of a mail message of the maintenance information received from each printer 10 to make the content understandable by the operator of the monitor console 12.

The decision condition information includes a decision condition 47 and a process content 48 corresponding to this decision condition 47, as shown in FIG. 7. The decision condition information includes a decision condition 47 unique to each type of the printers 10 and a process content 48 corresponding to this decision condition 47. The decision condition information also includes a decision condition 47, which is created newly for each printer 10 by the management server 11, based on the maintenance information of the printer 10, and a process content 48 corresponding to this decision condition 47.

The decision condition 47 includes a setting change decision condition 47a and a problem decision condition 47b. The setting change decision condition 47a is a condition under which the management server 11 decides that the setting condition of the printer 10 should be changed, and which is not directly associated with prediction of the occurrence of a problem. For example, it may be a condition “set time is deviated 30 seconds or more” in FIG. 7.

The problem decision condition 47b is a condition under which it is decided that a problem may occur soon. For example, it may be a condition “tone is 1% or less” in FIG. 7. When this condition is met, the management server 11 predicatively determines that a problem (problem originated from the run-out of the toner) may occur soon in that printer 10.

The “problem” particularly refers to predictable and treatable errors among errors that prevent the printer 10, which is a user apparatus, from performing the fundamental processes. The “problem” includes paper jamming and system error in the printer 10. The “problem” also includes an error that is caused by total consumption of consumables and disables the execution of the fundamental processes.

The process content 48 is the content of processes that are performed by the management server 11 when a decision condition 47 is satisfied and are so set as to correspond to each decision condition 47. In FIG. 7, each process content 48 corresponds to each decision condition 47 positioned to the left thereof. That is, when the printer 10 meets a decision condition 47, the management server 11 performs the process content 48 corresponding to that decision condition 47. In the case where the printer 10 meets the decision condition 47 indicating that “four paper jams at the A portion and one paper jam at the B portion have successively occurred” (see FIG. 7), for example, the management server 11 executes the process content 48 “send work information to a maintenance worker.” The process content 48 includes a change content 48a to change the settings of the printer 10. Specifically, at the time the decision condition 47 corresponding to the change content 48a is satisfied, the management server 11 changes the settings of the printer 10 to this change content 48a via the remote control computer 13. Suppose that the printer 10 has met the decision condition 47 indicating that “four paper jams at the A portion and one paper jam at the B portion have successively occurred,” as shown in FIG. 7. In this case, the maintenance and management center C rewrites point information (see FIG. 4) in the ROM 27 of the printer 10 in accordance with the change content 48a to the effect that “change the error point of the paper jam at the B portion to 10.”

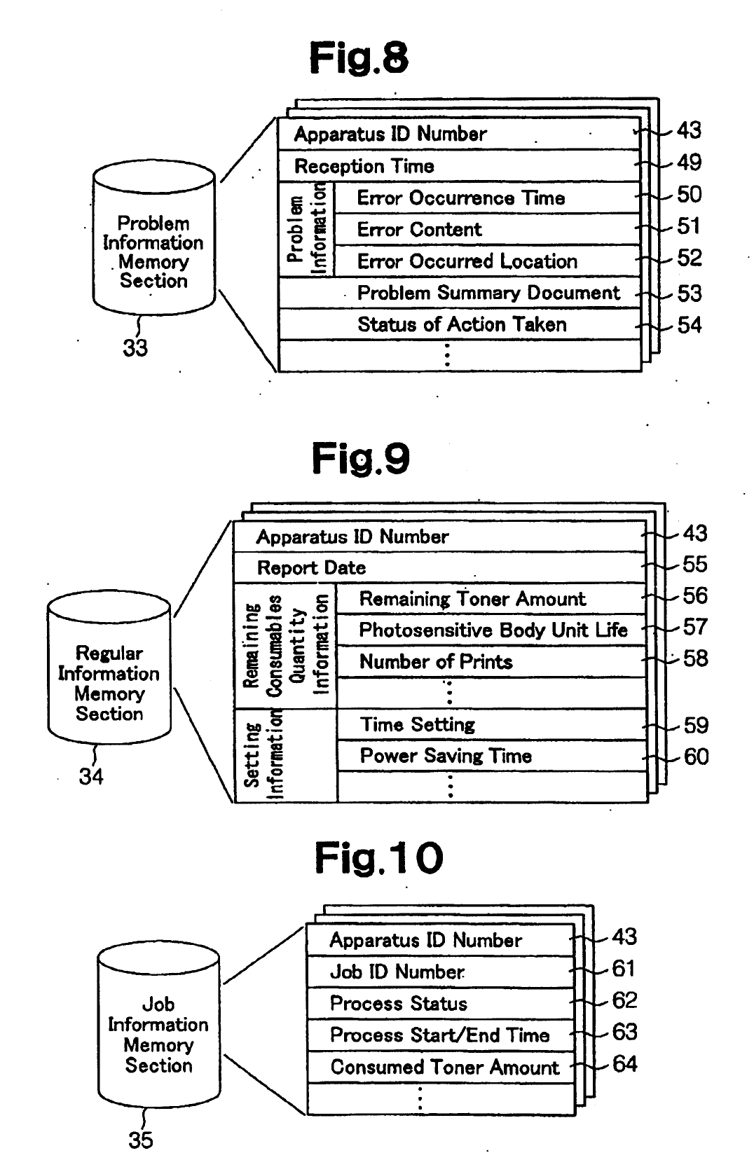

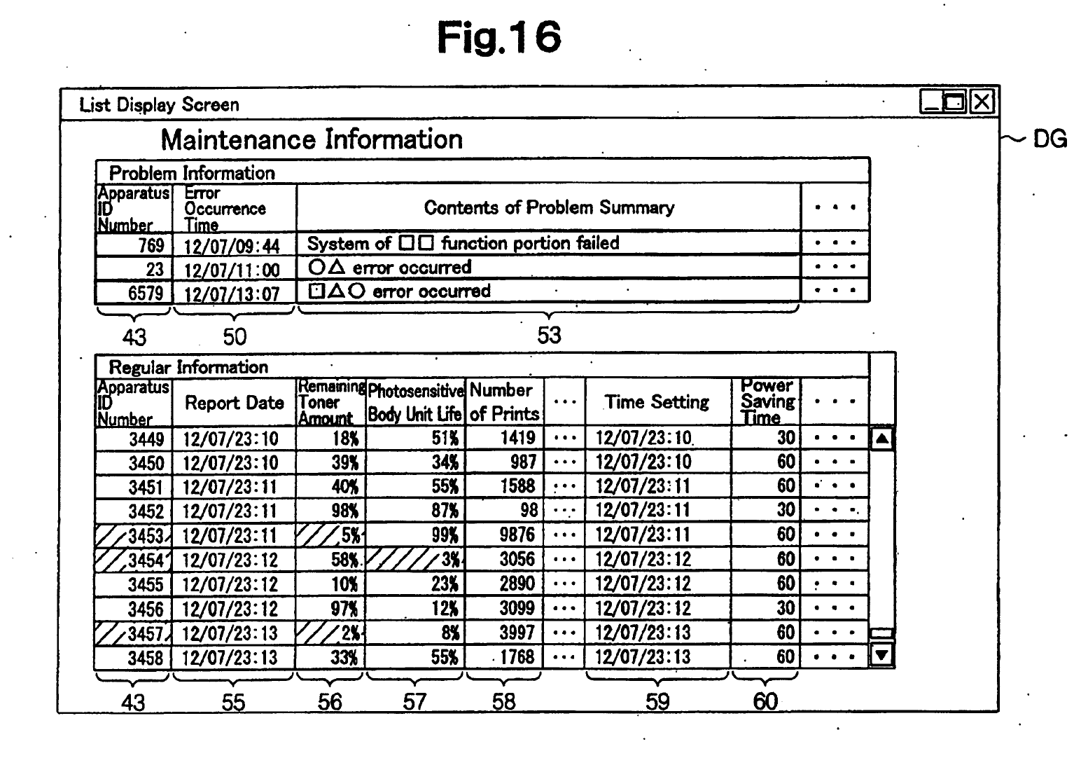

As shown in FIG. 8, the problem information memory section 33 stores the problem information received from the printer 10 and information relating thereto in association with the apparatus ID number 43 for each printer 10. Therefore, the problem information memory section 33 stores the apparatus ID number 43, a reception time 49, problem information (error occurrence time 50, error content 51, and error occurred location 52), a problem summary document 53, a status of action taken 54, and so forth. The reception time 49 is the time at which the printer 10 has sent problem information. The problem summary document 53 is the summary of the content of a problem and is a document (see FIG. 16) that is created based on the error content 51 and the error occurred location 52, and is displayed as a problem summary on the display 17 for the operator of the monitor console 12. The status of action taken 54 includes assignment of a maintenance worker and completion of a work, input by the operator of the monitor console 12, and a work content input from the portable terminal 18 of that maintenance worker.

As shown in FIG. 9, the regular information memory section 34 stores the regular information received from the printer 10 for each apparatus ID number 43 and for its report date 55. As shown in FIG. 10, the job information memory section 35 stores the job information received from the printer 10 for each print job and each apparatus ID number 43.

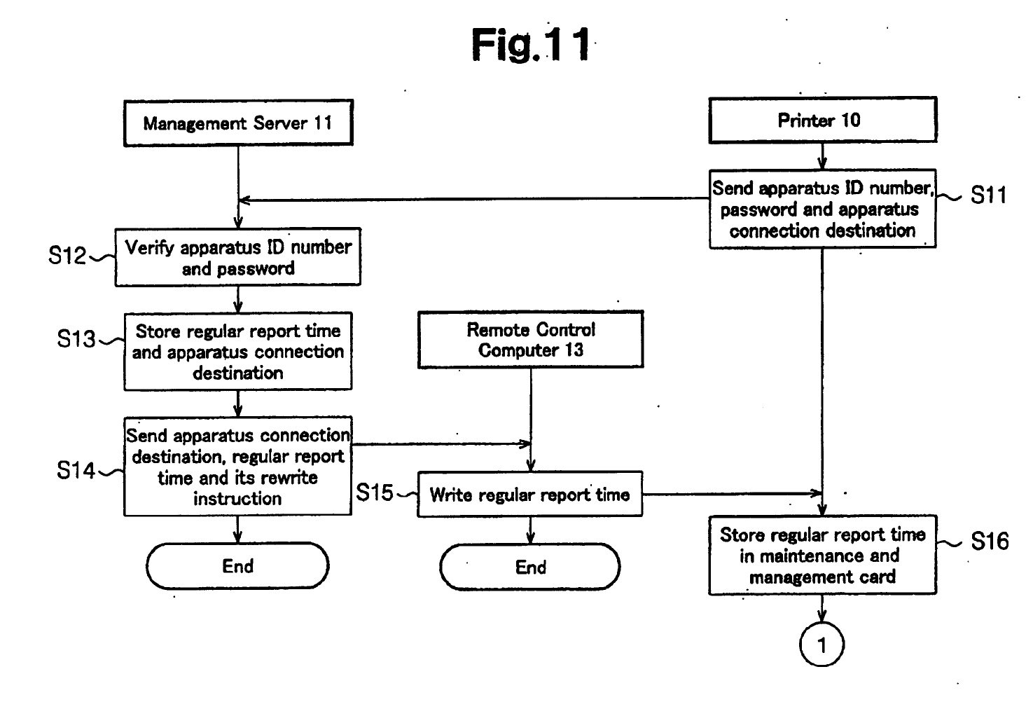

The operation of the apparatus maintenance system will now be described referring to FIGS. 11 to 18.

(Initialization of Printer 10)

In the case where a printer 10 is placed newly in a user's company, first, the printer 10 is initialized. The initialization will be discussed referring to FIG. 11.

As the printer 10 is powered up and becomes usable, the CPU 25 of the printer 10 connects to the management server 11 of the maintenance and management center C via the network N. Then, the printer 10 sends its apparatus ID number 43, the password 44, and the apparatus connection destination 45 to the management server 11 (step S11). The management server 11, first, compares the received apparatus ID number 43 and password 44 with information stored in the apparatus information memory section 31 to determine whether they are correct or not, i.e., perform verification (step S12).

If it is determined that the verification is proper, the management server 11 allocates the regular report time 46 for the printer 10 to a time different from those of other printers 10 that have already been placed. Next, the management server 11 stores the allocated regular report time 46, the received apparatus ID number 43, password 44, and apparatus connection destination 45 in the apparatus information memory section 31 (step S13). To store the allocated regular report time 46 in the maintenance and management card 22 of the printer 10, the management server 11 then sends the apparatus connection destination 45, the regular report time 46, and a rewriting instruction to the remote control computer 13 (step S14).

The remote control computer 13 connects to the printer 10 based on the received apparatus connection destination 45 and writes the regular report time 46 in the maintenance and management card 22 of the printer 10 (step S15). Accordingly, the regular report time 46 is stored in the maintenance and management card 22 (step S16).

(Maintenance and Management of Printer 10)

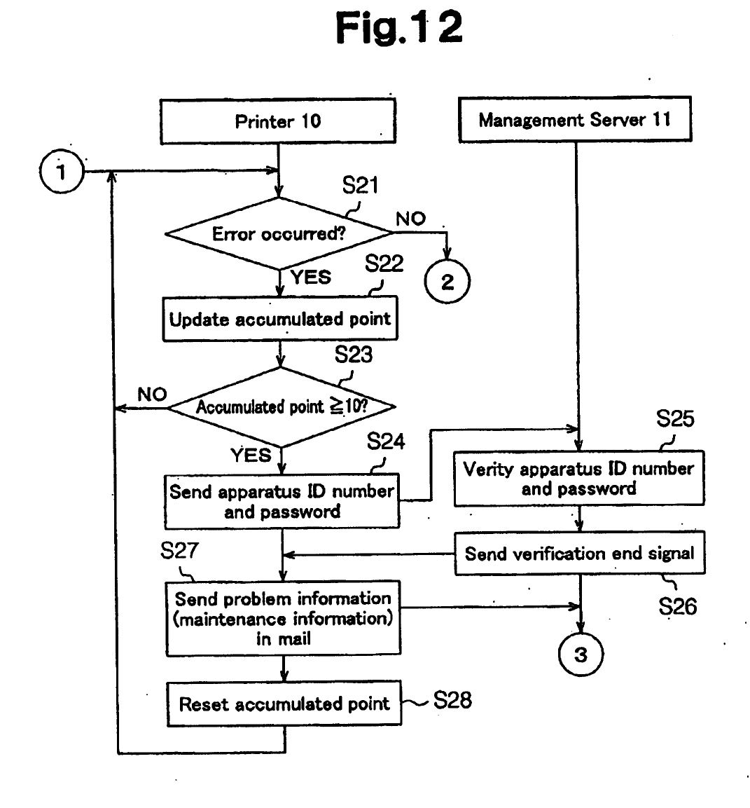

After the initialization is carried out as described above, a maintenance and management process illustrated in FIGS. 12 to 15 is executed while the printer 10 is being powered on.

In this maintenance and management process, the printer 10 first determines whether an error has occurred or not (step S21), as shown in FIG. 12. In the case where an error has occurred (YES in step S21), the printer 10 reads an error point corresponding to that error event from the ROM 27, and adds the error point to the accumulated error point stored in the RAM 26 to thereby update the accumulated error point (step S22). Subsequently, the printer 10 determines whether the accumulated error point has become equal to or greater than the transmission decision reference value of 10 (step S23).

When the accumulated error point is less than 10 (NO in step S23), the printer 10 returns to the process of step S21. When the accumulated error point has become equal to or greater than 10 (YES in step S23), the printer 10 sends the apparatus ID number 43 and the password 44 to the management server 11 first (step S24). The management server 11 performs verification as to whether or not the received apparatus ID number 43 and password 44 are stored in the apparatus information memory section 31 (step S25). When the management server 11 determines that the apparatus ID number 43 and the password 44 are correct in the verification, the management server 11 sends a verification end signal to the printer 10 (step S26). Upon reception of this verification end signal, the printer 10 sends all the error events corresponding to accumulated error points equal to or greater than 10 in a time-sequential manner to the management server 11 as problem information (step S27).

Suppose that “paper jamming at the A portion,” which is an error event corresponding to an error point of 1, has occurred twice; after which “paper jamming at the B portion,” which is an error event corresponding to an error point of 2, has occurred four times (see FIG. 4); and the accumulated error point becomes equal to or greater than 10. In this case, the printer 10 transits problem information (maintenance information) to the effect that paper jamming at the A portion 1 has occurred twice, and paper jamming at the B portion has occurred four times to the management server 11 in the form of mail via the network N. Then, the printer 10 resets the current accumulated error point to zero (step S28).

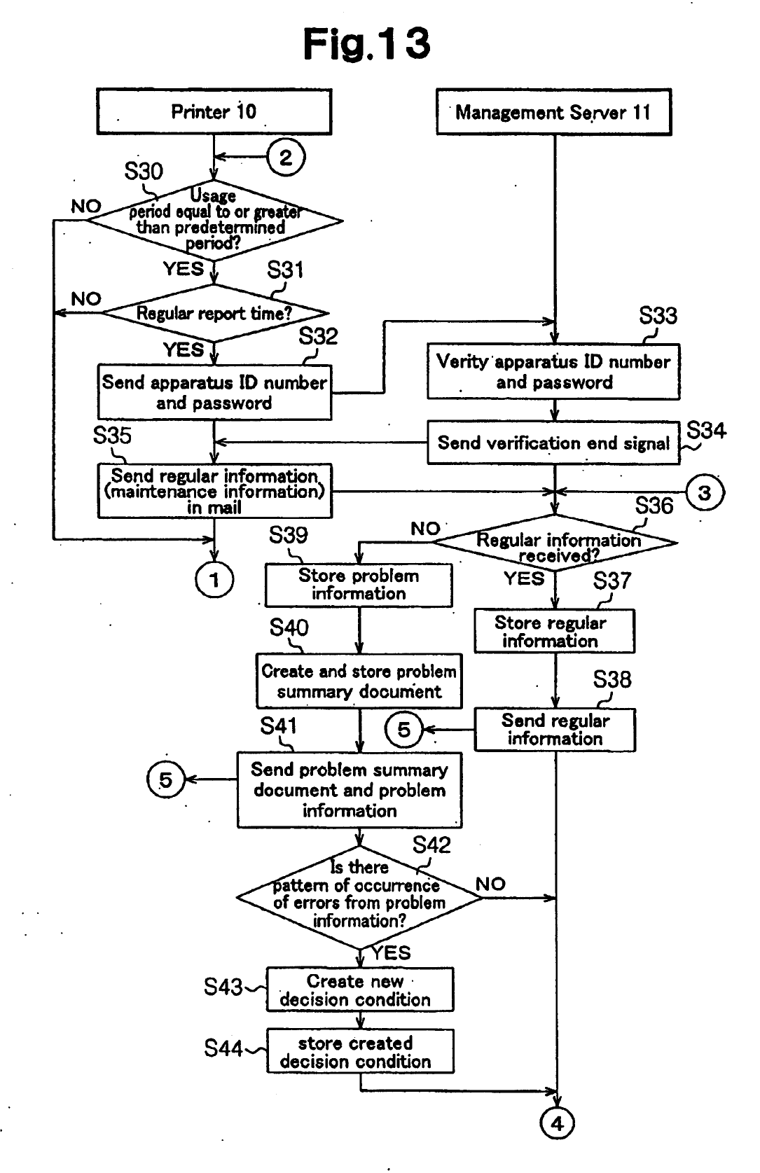

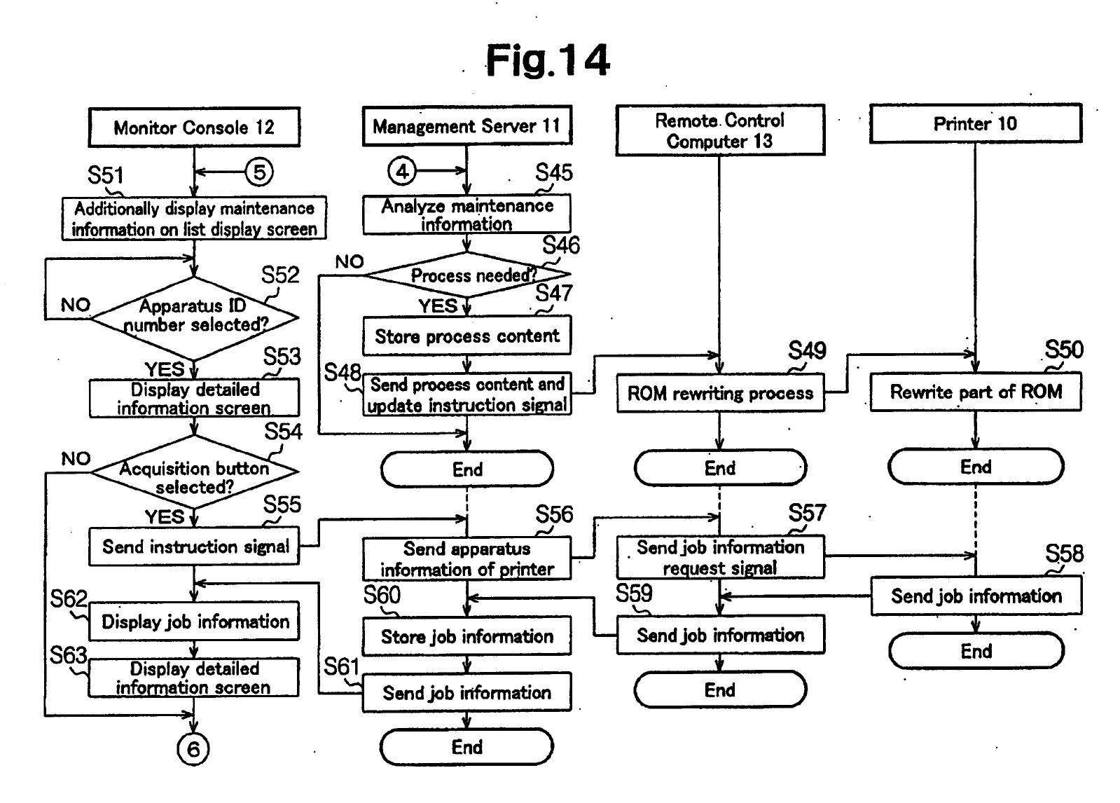

When the printer 10 decides in step S21 that no error has occurred (NO in step S21), on the other hand, the printer 10 determines whether or not the period of usage has become equal to or greater than a predetermined period, for example, over one month (step S30), as shown in FIG. 13. That is, it has not passed much since the use of the printer 10 was started (NO in step S30), the printer 10 returns to step S21 in FIG. 12. When the period of usage is equal to or greater than the predetermined period (NO in step S30), on the other hand, the printer 10 determines if the regular report time 46 has come (step S31). When the printer 10 has decided that the regular report time 46 has not come yet, it returns to step S21 in FIG. 12.

When the regular report time 46 has arrived, on the other hand, the verification process is carried out as done in steps S24 to S26 in FIG. 12. That is, the printer 10 sends the apparatus ID number 43 and the password 44 to the management server 11 (step S32), and the management server 11 performs verification in response to the transmission (step S33) and sends the verification end signal to the printer 10 if verification is correct (step S34). Upon reception of this verification end signal, the printer 10 sends regular information (maintenance information) to the management server 11 in the form of mail via the network N (step S35).

When the printer 10 sends maintenance information (problem information or regular information) in the form of mail in step S27 in FIG. 12 or step S35 in FIG. 13, the management server 11 receives the maintenance information. When a predetermined time comes, the management server 11 determines whether the received information is problem information or regular information, based on information stored in the analysis/decision condition information memory section 32 and the time the maintenance information was received (step S36). When the management server 11 has decided that the received information is regular information (YES in step S36), the management server 11 stores the regular information in the regular information memory section 34 (step S37) and sends the regular information to the monitor console 12 (step S38).

When the management server 11 has decided in step S36 that the received information is problem information, not regular information, on the other hand, the management server 11 stores the problem information in the problem information memory section 33 (step S39). Next, the management server 11 creates the summary document of the error content 51 or the problem summary document 53 and stores the document in the problem information memory section 33 (step S40). Then, the management server 11 sends the problem summary document 53 and problem information to the monitor console 12 (step S41).

Next, the management server 11 detects if some sort of a tendency pattern on the occurrence of the same significant error that has occurred in the printer 10 based on the received problem information of the printer 10 (step S42). Suppose that the event such that paper jamming always occurred four times at the A portion and once at the B portion immediately before the occurrence of a system error (significant error) in the printer 10 took place plural times in the past. In this case, when a system error occurs in the printer 10, the management server 11 detects that there is a tendency pattern such that “paper jamming always occurs four times at the A portion and once at the B portion.”

When having detected a tendency pattern in step S42, the management server 11 creates the tendency pattern as a new decision condition 47 and stores it in the analysis/decision condition information memory section 32 (steps S43 and S44). For example, the decision condition 47 to the effect that “paper jamming has occurred four times at the A portion and once at the B portion” is created in association with the aforementioned system error. In the present embodiment, the management server 11 further creates the process content 48 to the effect that “send work information to a maintenance worker” in association with the decision condition 47. When the decision condition 47 is met, it is likely that a system error will occur as a problem. Therefore, it is possible to send a maintenance worker to the company where the printer 10 is located based on the process content 48 and take some measures against the probable problem before the problem occurs based on the process content 48. In step S44, therefore, the management server 11 stores the decision condition 47 to the effect that “paper jamming has occurred four times at the A portion and once at the B portion” and the process content 48 to the effect that “send work information to a maintenance worker” in the analysis/decision condition information memory section 32 in association with each other.

Further, in the present embodiment, the management server 11 creates the decision condition 47 to the effect that “paper jamming has occurred four times at the A portion” and the corresponding change content 48a to the effect that “set the error point to 10 when paper jamming occurs at the B portion” and stores them in the analysis/decision condition information memory section 32.

That is, when the printer 10 meets the previously-created decision condition 47 to the effect that “paper jamming has occurred four times at the A portion and once at the B portion”, the management server 11 changes the settings in such a way that the information is transmitted immediately to the management server 11. Specifically, as the error point corresponding to the error event of “paper jamming at the B portion” is normally 2 (see FIG. 5), the change content 48a to change the error point to 10 is created. Then, a condition that is the previously-created decision condition 47 whose last half part is excluded, i.e., a condition to the effect that “four paper jams at the A portion” without the part “one paper jam at the B portion” is created as the decision condition 47 corresponding to that change content 48a. Accordingly, the management server 11 can swiftly detect that the decision condition 47 to the effect that “paper jamming has occurred four times at the A portion and once at the B portion” is satisfied.

Then, as shown in FIG. 14, the management server 11 analyzes the acquired maintenance information (step S45) and determines whether or not the printer 10 has met the decision condition 47 or whether or not the process corresponding to the decision condition 47 is needed (step S46). When a tendency pattern of occurrence of errors cannot be detected (NO in step S42 in FIG. 13) as in the case where, for example, a significant error has occurred only once, the management server 11 proceeds to the step S45 without executing the processes of steps S43 and S44 in FIG. 13.

In the case where the printer 10 has met the decision condition 47 in step S46, the management server 11 decides that a process corresponding to the decision condition 47 is needed and temporarily stores the process content 48 corresponding to that decision condition 47 in the unillustrated RAM in order to execute the process content 48 (step S47). In the case where the decision condition 47 to the effect that “paper jamming has occurred four times at the A portion” is met, for example, the management server 11 temporarily stores the change content 48a to the effect that “change the error point of paper jamming at the B portion to 10” corresponding to the decision condition 47. Even when the decision condition 47 to the effect that “paper jamming has occurred four times at the A portion and once at the B portion” is met, the management server 11 temporarily stores the process content 48 to the effect that “send work information to a maintenance worker” corresponding to that decision condition 47.

Next, in the case where the process content 48 is the change content 48a to change the settings of the printer 10, the management server 11 sends the remote control computer 13 an update instruction signal to rewrite the data in the ROM 27 of the printer 10 with the change content 48a (step S48). The remote control computer 13 performs remote manipulation of the printer 10 and data rewriting in the ROM 27 based on the change content 48a (step S49). Accordingly, with regard to the point information of the ROM 27 (see FIG. 4), the error point corresponding to the error event “paper jamming at the B portion” is rewritten to 10 in the printer 10 (step S50).

Meantime, the monitor console 12, which has received the maintenance information (regular information or problem information (including the summary document)), displays the maintenance information on a list display screen DG of the display 17 in a time-sequential manner (step S51). The problem information is displayed on the list display screen DG in a relatively noticeable color, such as red, (shown in a thick-lined frame in the diagram), and the regular information is displayed in a scrollable manner, as shown in FIG. 16. Further, the regular information is displayed in a color relatively noticeable and different from the color of the problem information, e.g., yellow, (shown in the hatched lines in the diagram) when hardly any consumables remains (e.g., the remaining quantity is equal to or less than 5%).

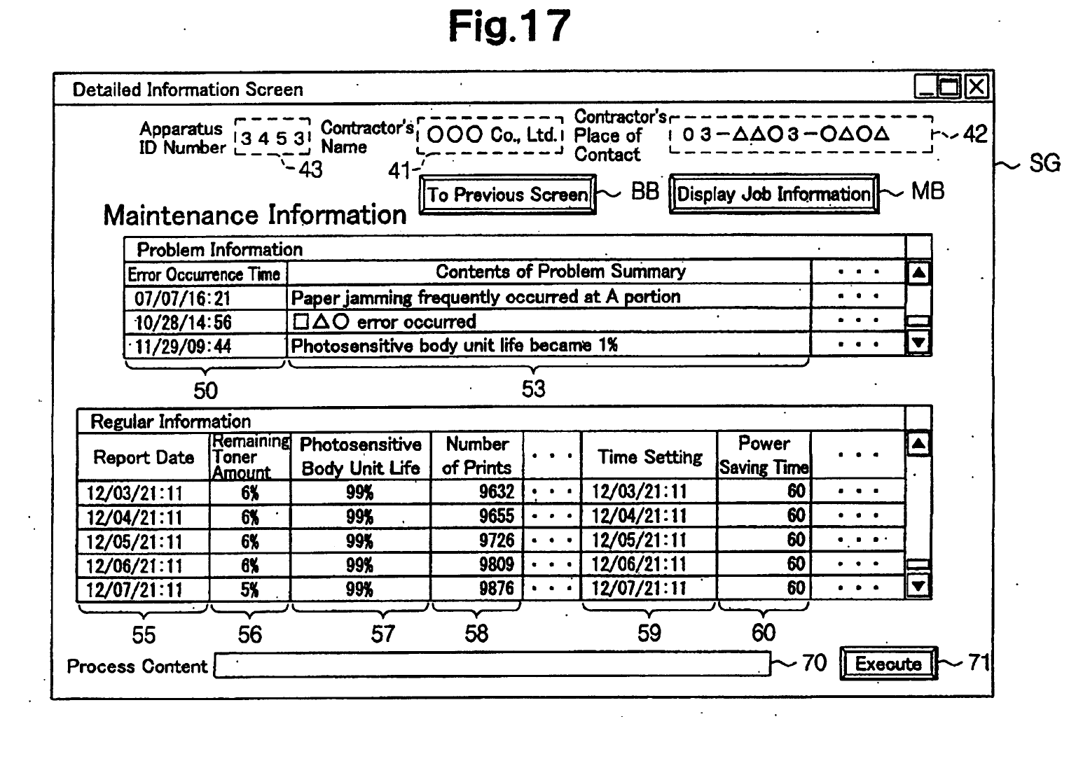

When the operator who is monitoring the display 17 clicks each apparatus ID number 43 in the maintenance information, the monitor console 12 determines that the apparatus ID number 43 has been selected (YES in step S52 in FIG. 14) and displays a detailed information screen SG as shown in FIG. 17 (step S53). Problem information and regular information of the printer 10, which have the selected maintenance information, are displayed on the detailed information screen SG. Further displayed on the detailed information screen SG are the contractor's name 41, the contractor's place of contact 42, and the apparatus ID number 43, as well as an acquisition button MB to acquire the job information of the printer 10 and a return button BB to return to the list display screen DG, which is the previous screen. A process content input field 70 and an execution button 71 to send a process content (instruction content) input in the input field 70 are also displayed on the detailed information screen SG.

In the case where the operator who is viewing the maintenance information has decided that further information is needed and wants to acquire job information, the operator clicks the acquisition button MB. Then, the monitor console 12 determines that job information is needed (YES in step S54 in FIG. 14), and an instruction signal to acquire job information is sent to the management server 11 (step S55). The management server 11 transmits the apparatus connection destination 45, which is apparatus information of the printer 10 to the remote control computer 13 based on the instruction signal (step S56). The remote control computer 13 connects to the printer 10 via the network N and transmits a request signal for the job information (step S57).

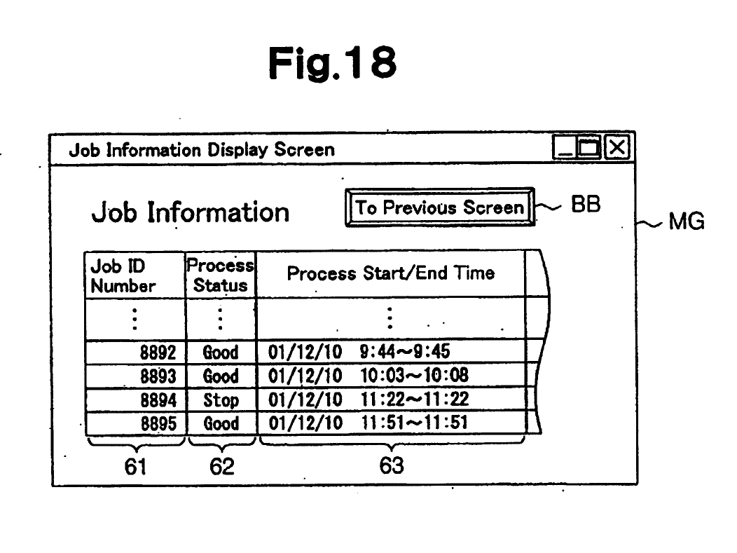

In response to the request signal, the printer 10 sends job information, which has not been transmitted to the maintenance and management center C yet, or information stored in the MIB 23 to the remote control computer 13 via the network N in the form of mail (step S58). The remote control computer 13 sends the received job information to the management server 11 (step S59). The management server 11 stores the received job information (step S60) and sends this job information to the monitor console 12 (step S61). Then, the monitor console 12 displays the job information on a job information display screen MG (step S62). As shown in FIG. 18, job information, such as the process status 62 and process start/end time 63, is displayed on the job information display screen MG for each job ID number 61 in addition to the return button BB to return to the detailed information screen SG, which is the previous screen. When the operator who has viewed the job information selects the return button BB, the monitor console 12 displays the detailed information screen SG in FIG. 17 on the display 17 again (step S63).

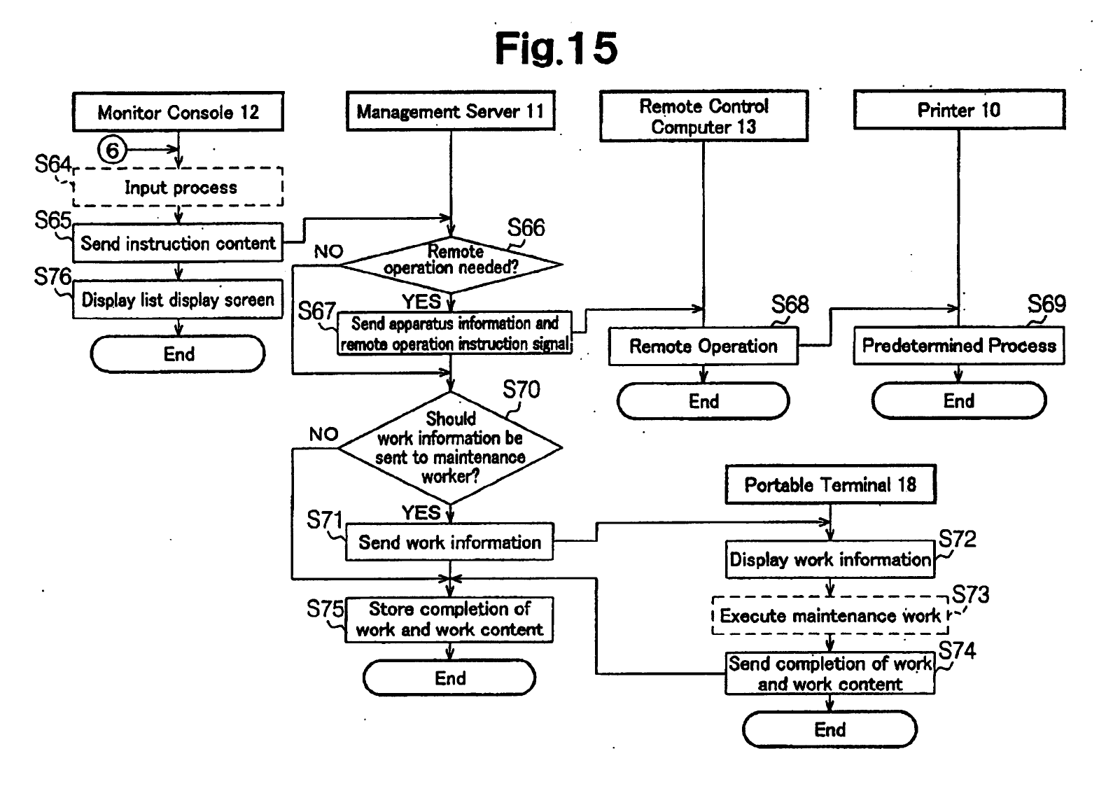

When the operator who is monitoring the detailed information screen SG decides, based on the viewed job information and maintenance information, that some process should be performed on the printer 10, the operator inputs the process content (instruction content) into the process content input field 70 of the detailed information screen SG (step S64 in FIG. 15) and clicks the execution button 71. Then, the monitor console 12 sends the input instruction content to the management server 11 (step S65).

The management server 11 analyzes the input instruction content and sends the apparatus information of the printer 10 to be remotely operated and a remote operation instruction signal to the remote control computer 13 (step S67) in the case where the analyzed instruction content includes a remote-operation based process (YES in step S66).

Based on the received apparatus information, the remote control computer 13 connects to the printer 10, which is to be remotely operated, and remotely operates the printer 10 (step S68). Based on the remote operation by the remote control computer 13, the printer 10 executes a predetermined process instructed such as head cleaning (step S69).

The management server 11 determines whether or not it is necessary to transmit work information about the printer 10 to the maintenance worker (step S70). When it is decided that the maintenance worker should be sent, based on the process content 48 stored in step S47 in FIG. 14 or the instruction content input in step S64 in FIG. 15 or based on the assigned area and the schedule of the maintenance worker that a regular inspection is scheduled, an affirmative decision is made in step S70. Note that work information is, for example, the recent error in the printer 10, the tendency pattern of the error, and measures against an error that is predicted to occur in the future.

When an affirmative decision is made in step S70, the management server 11 sends the work information to the portable terminal 18 (step S71). In the case where the management server 11 stores the process content 48 to the effect that “send work information to a maintenance worker” in step S43 in FIG. 13, the management server 11 sends apparatus information, such as the contractor's place of contact 42, corresponding to the printer 10 together with the work information in order to send the maintenance worker right away.

The portable terminal 18 displays the received work information on the display section 18a (step S72). The maintenance worker who has viewed the information displayed on the portable terminal 18 visits the company where the printer 10 is located and performs a maintenance work (or a regular inspection work) on the printer 10 (step S73). When the maintenance work is completed, the maintenance worker inputs the completion of the work and the work content into the portable terminal 18, which in turn sends that information to the management server 11 via the network N (step S74). Then, the management server 11 stores the received completion of the work and work content, as the status of action taken 54, in the problem information memory section 33 (step S75).

When the operator selects the return button BB on the detailed information screen SG, the monitor console 12, which has transmitted the instruction content in the step S65, displays the list display screen DG shown in FIG. 16 again on the display 17 (step S76).

The apparatus maintenance system according to the embodiment has the following advantages.

In the case where the management server 11 can determine that some process is needed, based on the decision condition 47 for predicting the occurrence of a problem (step S46 in FIG. 14), the management server 11 executes the process content 48 as its measure (e.g., transmission of work information to the maintenance worker). In the case where it is possible to predict that a problem will occur soon, some kind of measure can be taken against the predicted problem, for example, at the time of the maintenance worker does the regular inspection work or at the time of eliminating another error that has already occurred. As the decision condition 47 is generated for each printer 10, it is possible to carry out maintenance and management according to the characteristics of that printer 10. The management server 11 can therefore maintain the printer 10 efficiently.

In the case where a condition excluding the last condition when the occurrence of a system error, which is a significant error, can be predicted is satisfied, the management server 11 remotely operates the printer 10 via the remote control computer 13 and changes the contents of the ROM 27 (steps S49 and S50 in FIG. 14). Specifically, the weight of the error point that corresponds to the error event is changed in the ROM 27 of the printer 10. In the case where the condition, “paper jamming has occurred four times at the A portion”, in the decision condition 47 to the effect that “paper jamming has occurred four times at the A portion and once at the B portion” is satisfied, for example, the error point that corresponds to the error event of “paper jamming at the B portion” is changed to 10 from 2. As the contents of the ROM 27 of the printer 10 are changed, therefore, the management server 11 can more quickly know the state in which the occurrence of a significant system error can be predicted. This makes it possible to cope more quickly with a problem that will occur in the future. Therefore, the management server 11 can efficiently perform remote maintenance of each printer 10.

In the case where the occurrence of a problem in the printer 10 in the near future is predictable, the management server 11 can always monitor to see if the problem has occurred by frequently transmitting maintenance information to the printer 10. In the case where the management server 11 determines that a problem in the printer 10 will not occur for some time because, for example, parts of the printer 10 that frequently had errors were replaced with new parts, the management server 11 can reduce the burden on the process associated with maintenance information by changing the settings of the printer 10 in a way that reduces the transmission frequency of the maintenance information. The management server 11 can therefore perform remote maintenance of each printer 10 more efficiently in accordance with the condition under which a problem can be predicted quickly, while reducing the burden on the maintenance process.

In the case where the management server 11 detects a tendency pattern of an error in each printer 10 from maintenance information obtained from that printer 10, the management server 11 generates a new decision condition 47 (steps S42 and S43 in FIG. 13). In other words, the management server 11 determines whether or not to update the decision condition 47 of the printer 10 (particularly, the setting change decision condition 47a) in consideration of the status of the usage of each printer 10 and the tendency pattern of the occurrence of errors, i.e., the characteristics of each printer 10. Therefore, the management server 11 can grasp an error that is likely to occur for each printer 10, more adequately predict an error that will occur in each printer 10, and prepare for the error, so that an error that will occur in each printer 10 in the future can be coped with more swiftly.

Maintenance information includes problem information about an error, so that in the case where a significant error has occurred, which cannot be removed easily by a user, it is possible to send a maintenance worker and quickly eliminate the error.

The management server 11 stores remaining consumables quantity information, such as the remaining toner amount 56, the photosensitive body unit life 57, and the number of prints 58, as maintenance information, in the regular information memory section 34 as regular information (step S37 in FIG. 13). Based on the regular information stored in the regular information memory section 34, therefore, the timing at which consumables will be completely used up can be grasped, making it possible to prepare for the occurrence of an error originated from the complete run-out of the consumables and promote the sales of the consumables.

The printer 10 does not send maintenance information (regular information) to the management server 11 for a predetermined period since the beginning of the usage or a period where errors are unlikely to occur (NO in step S30 in FIG. 13). The communication cost can therefore be suppressed by the amount equivalent to the period over which the printer 10 does not send maintenance information.

In accordance with the instruction content input by the operator who is monitoring the monitor console 12, work information is transmitted to the portable terminal 18 of the maintenance worker who does direct maintenance of the printer 10 (step S71 in FIG. 15). As the maintenance worker can easily perform the maintenance work based on the work information displayed on the portable terminal 18 (steps S72 and S73), the operator can quickly restore the printer 10 in which the error has occurred. p In the case where the maintenance work by the maintenance worker is completed, the management server 11 receives the completion of the work and the work content from the portable terminal 18 and stores them as the status of action taken 54 (step S75 in FIG. 15). By referring to the status of action taken 54, received as problem information with respect to the error that is the target for the maintenance work, the management server 11 can maintain and manage the printer 10 more efficiently when a similar error occurs again.

The remote control computer 13 can perform a remote operation of a process, such as flashing, on the printer 10 (steps S68 and S69 in FIG. 15). It is therefore possible to eliminate quickly the error that could not be removed by the user and restore the printer 10 without sending a maintenance worker.

When a printer 10 is set, the remote control computer 13 stores the regular report time 46 of that printer 10 in the maintenance and management card 22 (steps S15 and S16 in FIG. 11). After the printer 10 is set, therefore, the regular report time 46 can be set and changed in association with the apparatus connection destination 45 and apparatus ID number 43 of that printer 10. That is, it is unnecessary to set beforehand different regular report times 46 in the maintenance and management card 22, installed in each printer 10, and it is possible to install the same maintenance and management card 22 in individual printers 10. This can eliminate the cost for the setting of the regular report time 46.

The management server 11 acquires job information of the printer 10 via the remote control computer 13 based on the operation by the operator who is monitoring maintenance information (steps S55 to S62 in FIG. 14). That is, the management server 11 can acquire information about the detailed status of the printer 10 that has transmitted problem information, as needed, so that the error that has occurred in the printer 10 can be coped with swiftly.

In the case where an error has occurred, the printer 10 accumulates the error point corresponding to that error and transmits all the error events corresponding to the accumulated error point as problem information to the management server 11 when the accumulated error point becomes equal to or greater than 10 (steps S23 and S27 in FIG. 12). A large error point is given to a significant error event. If a significant error has occurred even once, problem information is transmitted to the management server 11 immediately so that the significant error can be coped with quickly. A light error can be eliminated quickly by a user himself without waiting for a maintenance worker. Therefore, a small error point is given to a light error event, so that some pieces of problem information about light errors are collected and transmitted to the management server 11. This results in reduction in communication cost. As the management server 11 can acquire information on such a light error, the management server 11 can obtain greater pieces of information needed to predict a problem. The management server 11 can therefore maintain and manage the printer 10 more adequately based on a large amount of maintenance information.

The management server 11 receives setting information, such as the time setting 59 and power saving time 60, together with remaining consumables quantity information, as regular information. In the case where this setting information meets the setting change decision condition 47a, the management server 11 can set the printer 10 again more adequately to thereby reduce the running cost.

The embodiment above may be modified as follows.

The printer 10 to be remotely maintained may be, for example, a combined machine equipped with a facsimile capability and copy capability, or an apparatus that has only one of the capabilities.

At the time a significant error that should be quickly coped with occurs, the operator of the monitor console 12 may be informed of problem information immediately.

In the embodiment above, transmission between the remote control computer 13 and the printer 10 is done in the form of mail. This mail may be data in the MIB 23, which is directly transmitted and is analyzed based on mail analysis information in the analysis/decision condition information memory section 32, or it may be a file of another format, such as the XML (Extensible Markup Language) format. The remote control computer 13, if combined with an interpreter, may execute remote control on the printer 10 by sending its condition statement itself. Further, the means for transmission and reception should not necessarily be limited to mail, but FTP (File Transfer Protocol) and HTTP (Hypertext Transfer Protocol) can be used as well.

Every time an error occurs, the printer 10 may send the error as problem information to the management server 11.

In the embodiment, the change content 48a that is executed in accordance with the decision condition 47 is alteration of the weight of an error, such as “change the error point to 10”, or the time setting of the management server 11 (see FIG. 7). The change content 48a is not limited to this type, but the maintenance-oriented settings to be updated may be alteration of the transmission frequency for maintenance information and regular report time 46 (transmission time for maintenance information) or alteration of a transmission item in job information. The transmission item that is to be transmitted to the management server 11 from a user apparatus may be changed according to the number of prints (the period of usage) or the number of years elapsed (since the manufacture). In this case, a problem that will occur can be coped with quickly by increasing the transmission frequency for maintenance information when it comes close to the endurance period.

Although the management server 11 changes the maintenance-oriented settings based on maintenance information in the embodiment, the decision condition 47 may be created based on job information so that a problem is predicted or the settings of the printer 10 are changed based on the decision condition 47. In the case where the management server 11 had decided from job information that “the interval between individual jobs is always 30 to 50 minutes in one month” as shown in FIG. 7, the management server 11 may “change the power saving time to 30 minutes.” In this case, the management server 11 functions as job information recording means to record job information received from a user apparatus.

Although the computer network that connects the management server 11 to the printer 10 and the communication network that connects the management server 11 to the portable terminal 18 have been described as a single network N in the foregoing description of the embodiment, separate exclusive networks may of course be used.

Although only a plurality of embodiments have been described herein, it should be apparent to those skilled in the art that the invention may be embodied in many other specific forms without departing from the spirit or scope of the invention. Therefore, the invention is not to be limited to the details given herein, but may be modified within the scope and equivalence of the appended claims.

1. A method in which a server computer performs remote maintenance by monitoring a user apparatus via a computer network, the method comprising:
a step that records maintenance information received from said user apparatus;
a step that generates and stores a decision condition for predicatively determining occurrence of a problem in said user apparatus based on plural pieces of said maintenance information; and
a step that predicatively determines occurrence of a problem in said user apparatus based on said decision condition and said maintenance information.

2. The method according to claim 1, further comprising:
a step that records a change content indicating how maintenance-oriented settings of said user apparatus are to be changed when said decision condition is met, in association with that decision condition; and
a step that transmits said change content corresponding to said decision condition to said user apparatus and updates said maintenance-oriented settings of said user apparatus when said decision condition is met.

3. The method according to claim 2, wherein said maintenance-oriented settings of said user apparatus includes weights respectively set in association with errors that may occur in said user apparatus and said change content includes a process content for changing said weights of said errors.

4. The method according to claim 2, wherein said change content includes a process of changing a weight of said maintenance information.

5. The method according to claim 1, wherein said maintenance-oriented settings of said user apparatus include an error point set in association with each of errors that may occur in said user apparatus and said user apparatus transmits said maintenance information when an accumulated value of said error point reaches a predetermined reference value.

6. The method according to claim 5, further comprising:
a step that records a change content indicating to what point said error point is to be changed when said decision condition is met, in association with that decision condition; and
a step that transmits said change content corresponding to said decision condition to said user apparatus and changes said error point, when said decision condition is met.

7. The method according to claim 1, wherein said maintenance information includes problem information about an error occurred in said user apparatus.

8. The method according to claim 1, wherein said maintenance information includes quantity information of remaining consumables of said user apparatus.

9. The method according to claim 1, wherein said maintenance information includes setting information of said user apparatus, said method further comprising:
a step that determines whether or not said setting information included in said maintenance information received indicates a predetermined condition; and
a step that changes settings of said user apparatus when said setting information does not indicate said predetermined condition.

10. The method according to claim 1, further comprising a step that transmits work information about maintenance of said user apparatus via a communication network to a portable terminal carried by a worker, who performs maintenance of said user apparatus.

11. A method in which a server computer performs remote maintenance by monitoring a user apparatus via a computer network, the method comprising;
a step that records job information received from said user apparatus;
a step that generates and stores a decision condition for predicatively determining occurrence of a problem in said user apparatus based on plural pieces of said job information; and
a step that predicatively determines occurrence of a problem in said user apparatus based on said job information received from said user apparatus through collation with said decision condition.

12. The method according to claim 11, further comprising:
a step that records a change content indicating how maintenance-oriented settings of said user apparatus are to be changed when this decision condition is met, in association with said decision condition; and
a step that transmits said change content corresponding to said decision condition to said user apparatus and updates said maintenance-oriented settings of said user apparatus when said decision condition is met.

13. A server computer, connected to a user apparatus via a computer network, for performing remote maintenance by monitoring the user apparatus, said server computer comprising:
recording means that records maintenance information received from said user apparatus;
generation means that generates and stores a decision condition for predicatively determining occurrence of a problem in said user apparatus based on said maintenance information; and
decision means that predicatively determines occurrence of a problem in said user apparatus based on said decision condition and said maintenance information.

14. The server computer according to claim 13, further comprising updating means that transmits said user apparatus a change content indicating how maintenance-oriented settings of said user apparatus are to be changed and updates said maintenance-oriented settings of said user apparatus, when said decision condition is met.

15. The server computer according to claim 13, further comprising transmission means that transmits work information about maintenance of said user apparatus via a communication network to a portable terminal carried by a worker, who performs maintenance of said user apparatus.

16. An electronic apparatus, which is monitored by a server computer present at a remote location through execution of transmission and reception of information with said server computer, the electronic apparatus comprising:
apparatus updating means that updates maintenance-oriented settings when receiving a new decision condition for prediction of occurrence of a problem from said server computer.

17. The electronic apparatus according to claim 16, further comprising:
means that stores an error, which may occur on said electronic apparatus, and an error point, weighted in accordance with that error, in association with each other;
means that, when said error occurs, accumulates an error point corresponding to that error; and
means that transmits a content of an error corresponding to said accumulated error point to said server computer when an accumulated value of said error point reaches a predetermined reference value.

18. An electronic apparatus, which is monitored by a server computer present at a remote location through execution of transmission and reception of information with said server computer, the electronic apparatus comprising:
means that receives a setting condition from said server computer and stores this setting condition.

19. The electronic apparatus according to claim 18, further comprising:
means that stores an error that may occur in said electronic apparatus, and an error point, weighted in accordance with that error, in association with each other;
means that, when said error has occurred, accumulates an error point corresponding to that error; and
means that transmits a content of an error corresponding to said accumulated error point to said server computer when an accumulated value of said error point reaches a predetermined reference value.
